(19) United States
(12) Patent Application Publication
(10) Pub. No.: US 2003/0057675 A1
(43) Pub. Date: Mar. 27, 2003

(54) Aligning and coupling a vehicle to a trailer

(76) Inventor: Geoff Grantland, Smyrna, DE (US)

Correspondence Address: Mr. Walter J. Tencza Jr., Suite 3, 10 Station Place, Metuchen, NJ, 08840, US

(21) Appl. No.: 09/962,183

(22) Filed: Sep. 25, 2001

(51) Int. Cl. B60D 1/00

(52) U.S. Cl. 280/477; 280/511

(57) ABSTRACT

An apparatus comprising a device for aligning a vehicle with a trailer is disclosed. The device includes a first member which is fixed to the vehicle and which extends outward from the back of the vehicle and a second member which is fixed to the trailer and extends upward from the trailer. The first member and the second member can be aligned and the aligning of the first and second members also aligns a first coupling device of the vehicle and a second coupling device of the trailer. The first and second coupling devices when aligned can be coupled together to couple the vehicle to the trailer. The second member may extend upward beyond the bottom of a rear windshield of the vehicle, when the first and second coupling devices are coupled together. The second member may include a pole portion which extends upward substantially perpendicularly to a horizontal beam member of the trailer. The first member may be a forked member which may include first and second prongs. The pole portion can fit within a region substantially encompassed by the first and second prongs.

### FIELD OF THE INVENTION

This invention relates to improved methods and apparatus concerning coupling or connecting a vehicle to a trailer.

### BACKGROUND OF THE INVENTION

Typically in the prior art a person has to go through a process of trial and error in order to back up a vehicle and couple the vehicle to a trailer. Such a process is tedious and time consuming and often requires an individual outside the vehicle providing directions.

### SUMMARY OF THE INVENTION

The present invention in or more embodiments discloses an apparatus comprising a device for aligning a vehicle with a trailer. The device includes a first member which is fixed to the vehicle and which extends outward from the back of the vehicle and a second member which is fixed to the trailer and extends upward from the trailer. The first member and the second member can be aligned and the aligning of the first and second members also aligns a first coupling device of the vehicle and a second coupling device of the trailer. The first and second coupling devices when aligned can be coupled together to couple the vehicle to the trailer.

The second member may extends upward beyond the bottom of a rear windshield of the vehicle, when the first and second coupling devices are coupled together. The second member may include a pole portion which extends upward substantially perpendicularly to a horizontal beam member of the trailer. The first member may be a forked member which may include first and second prongs. The second member may include a pole portion which can fit within a region substantially encompassed by the first and second prongs.

The second member may include a U-shaped portion which is connected to the pole portion and a flange of the second coupling device of the trailer can be inserted into the U-shaped portion to fix the second member to the trailer. The first member may be fixed to the vehicle by passing the first member through a hollow tube and fixing the first member to the hollow tube, wherein the hollow tube is fixed to the vehicle. The first member may be adjustable so that the first member can be fixed to extend outward different distances from the back of the vehicle.

The first member may be fixed to the vehicle so that the region substantially enclosed by the first and second prongs lies directly above a member of the first coupling device which is directly connected to the second coupling device. The member of the first coupling device which is directly connected to the second coupling device may be shaped substantially in the form of a ball.

The present invention also discloses a method comprising the steps of fixing a first member to a vehicle, so that the first member extends outward from the back of the vehicle and fixing a second member to a trailer, so that the second member extends upward from the trailer. The first member and the second members can be aligned and aligning the first and second members also aligns a first coupling device of the vehicle and a second coupling device of the trailer; and the first and second coupling devices when aligned can be coupled together to couple the vehicle to the trailer.

### BRIEF DESCRIPTION OF THE DRAWINGS

FIG. 1 shows a perspective view of a portion of a pickup truck, a portion of a trailer, and a device in accordance with an embodiment of the present invention for aligning the pickup truck with the trailer;

FIG. 2 shows a perspective view of the components of FIG. 1 after the pickup truck has been backed up;

FIG. 3 shows a perspective view of the components of FIG. 1 after portion of the trailer has been lowered so that it can be connected to the pickup truck;

FIG. 4 shows a front view of a member for attaching to the portion of the trailer in accordance with an embodiment of the present invention for aligning the pickup truck with the trailer;

FIG. 5 shows a perspective view of the full pickup truck and the full trailer connected together and a device for aligning the pickup truck with the trailer;

FIG. 6A shows an alternative forked member in accordance with another embodiment of the present invention; and

FIG. 6B shows a device for connecting a forked member to a vehicle in accordance with various embodiments of the present invention.

### DETAILED DESCRIPTION OF THE DRAWINGS

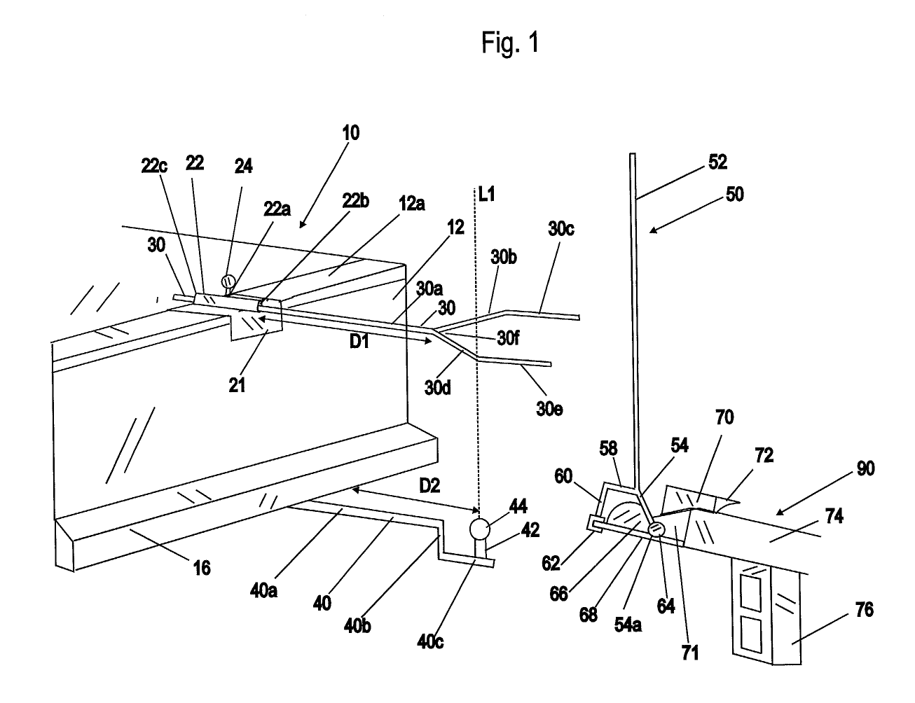

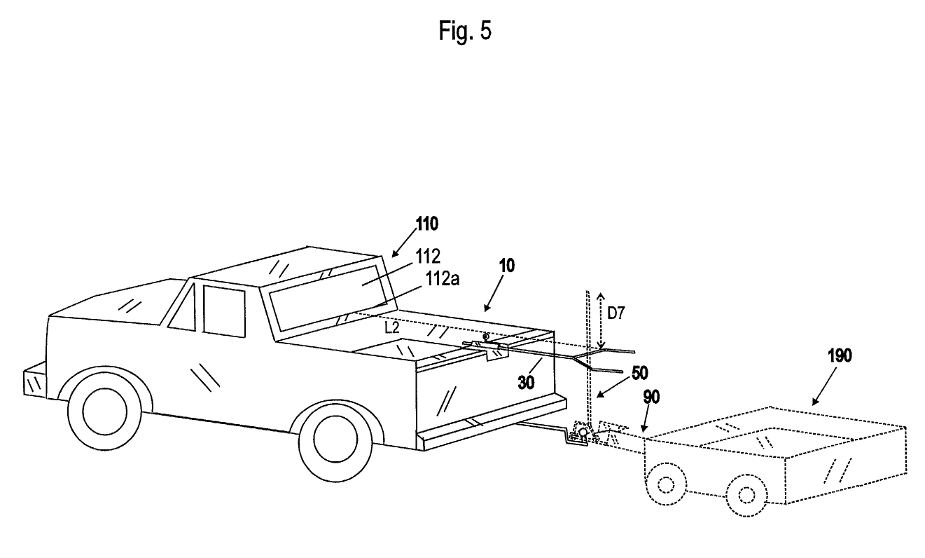

FIG. 1 shows a perspective view of a portion 10 of a pickup truck 110 (shown in full in FIG. 5), a portion 90 of a trailer 190 (shown in full in FIG. 5), and a device in accordance with an embodiment of the present invention for aligning the pickup truck 110 with the trailer 190 or aligning the portion 10 with the portion 90. The pickup truck 110 may be replaced by some other type of vehicle such as a passenger car, a minivan, or a sport utility vehicle.

The portion 10 of the pickup truck 110 includes back panel 12, and bumper 16. The portion 90 of the trailer 190 includes a rounded portion 66, a flange 68, a member 70, a member 71, a member 72, and a beam 74. The rounded portion 66 which may be in the shaped of a hollowed out dish, may be considered to be part of a coupling device for connecting or coupling the portion 90 of the trailer 190 with the pickup truck 110. The portion 10 of the pickup truck 110 also includes a member 40 which is attached to the bumper 16 and/or to the back panel 12. The member 40 has a straight portion 40a, a vertical portion 40b, and a straight portion 40c. The member 40 is connected to a member 42 which is connected to a solid ball member 44. The ball member 44 may be considered to be part of a coupling device connected to or part of the vehicle or pickup truck 110, for coupling or connecting to rounded portion 66 of the trailer portion 90. The distance from the back of the bumper 16 to the center of the ball member 44 may be D2 inches which may vary by vehicle, make, and/or model.

The device for aligning the pickup truck 110 with the trailer 190 includes a clamp 21, a tube 22, a screw 24, and a forked member 30. The clamp 21 is fixed to the back panel 12 in any known manner, such as by screws, by welding, or by industrial strength glue. The tube 22 is fixed to the clamp 21 in any known manner such as by screws, by welding or by industrial strength glue. The tube 22 is hollow with an additional opening 22a which is threaded for screw 24. The forked member 30 is comprised of straight portion 30a, angled portions 30b and 30d, and straight extensions 30c and 30e. The straight portion 30a should extend or project out perpendicularly to the back panel 12 of the portion 10 of the pickup truck 110. All the portions of the forked member 30 may be solid cylinders or rods which may have an outer diameter of one-quarter (¼) of an inch. The angled portion 30b and straight portion 30c may be considered to be one prong and the angled portion 30d and straight portion 30e may be considered to be another prong of the forked member 30. The straight portion 30a is shown in FIG. 1 inserted through an opening 22b at one end of the hollow tube 22 and which comes out the opening 22c at the other end of the hollow tube 22. Screw 24 is shown screwed into opening 22a of tube 22. Screw 24 is screwed in so that it contacts straight portion 30a of the forked member 30 and holds the forked member fixedly in place. The inner diameter of the tube 22 from opening 22b to opening 22c can be just slightly larger than the outer diameter of the portion 30a of the forked member 30. In this way the forked member cannot move or rotate substantially while in the tube 22.

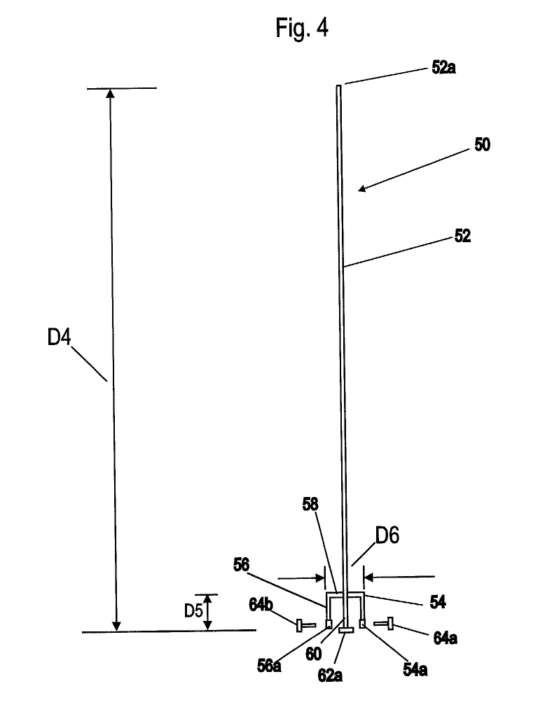

The device for lining the pickup truck 110 with the trailer 190 also includes a member 50 which is attached to the portion 90 of the trailer 190. The member 50 includes a pole portion 52, a portion 58, a portion 60, a U-shaped portion 62, diagonal portions 54 and 56 (shown in FIG. 4), ringed portions 54a and 56a. The pole portion may be a solid cylinder having an outer diameter of one-quarter (¼) of an inch. The ringed portions 54a and 56a can be threaded. The member 50 is connected to the portion 90 of the trailer 190 by screws 64a and 64b which are screwed into ringed portions 54a and 56a, respectively. The screws 64a and 64b are screwed in until they contact the rounded portion 66 of the portion 90 of the trailer 190. The screws 64a and 64b hold the member 50 securely to the rounded portion 66 and thus to the trailer 190. The member 50 is held so that the pole portion 52 is fixed in a substantially vertical position and the pole portion 52 is substantially perpendicular to the beam 74 of the trailer 190. The flange 68 of the trailer 190 fits into the U-shaped member 62 and this also prevents the member 50 and pole portion 52 from moving.

In operation, an individual first lifts up the portion 90 of the trailer 190 and places the portion 90 onto a cinder block 74 as shown in FIG. 1. If the trailer 190 or the trailer portion 90 is too heavy to manually lift, the individual would have to use certain known equipment or equipment on their trailer 190 to lift the trailer portion 90 to the correct height. The portion 90 needs to be raised so that the ball member 44 of the portion 10 of the pickup truck 110 can pass underneath the rounded portion 66 of the trailer 190 and the ball member 44 can be lined up with the rounded portion 66 without the two components colliding.

The individual may next insert the portion 30a of the forked member 30 into the tube 22 and screw the screw 24 into the tube 22 to hold the forked member 30 in place in the state shown in FIG. 1. The distance, D1, from the point 30f at an end of the straight portion 30a to the back panel 12 can be adjusted. This can be done by unscrewing the screw 24 and sliding the straight portion 30a to the appropriate distance D1 and then screwing in the screw 24 into the opening 22a to fix the location of forked member 30. The forked member portions 30b, 30c, 30d, and 30e should line up over the ball member 44, so that a vertical line segment L1, shown in FIG. 1, which is perpendicular to the ball member 44 and which passes through the center of the ball member 44, also passes through the region 30g substantially encompassed by the forked member portions 30b, 30c, 30d, and 30e. The line segment L1 should pass near to the point 30f at the end of the straight portion 30a of the forked member 30.

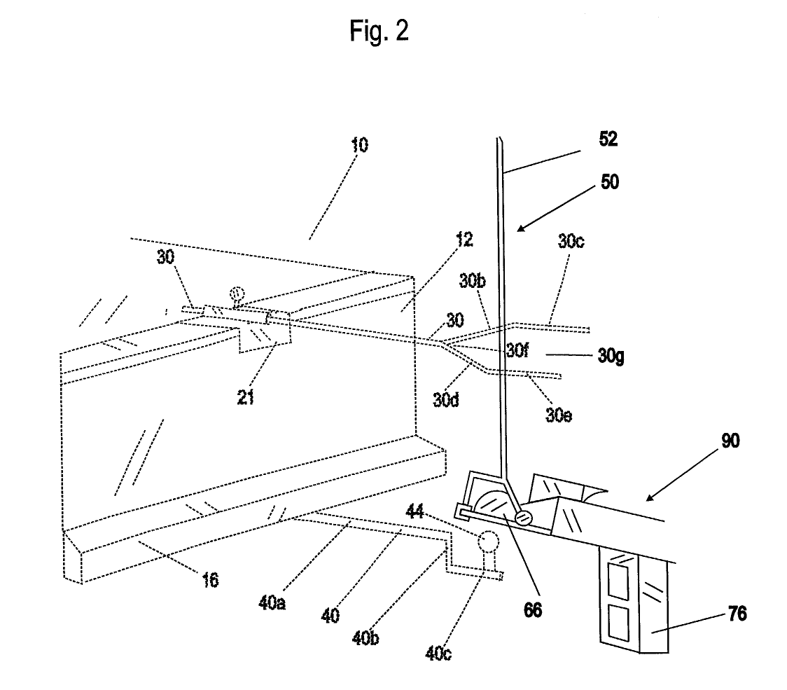

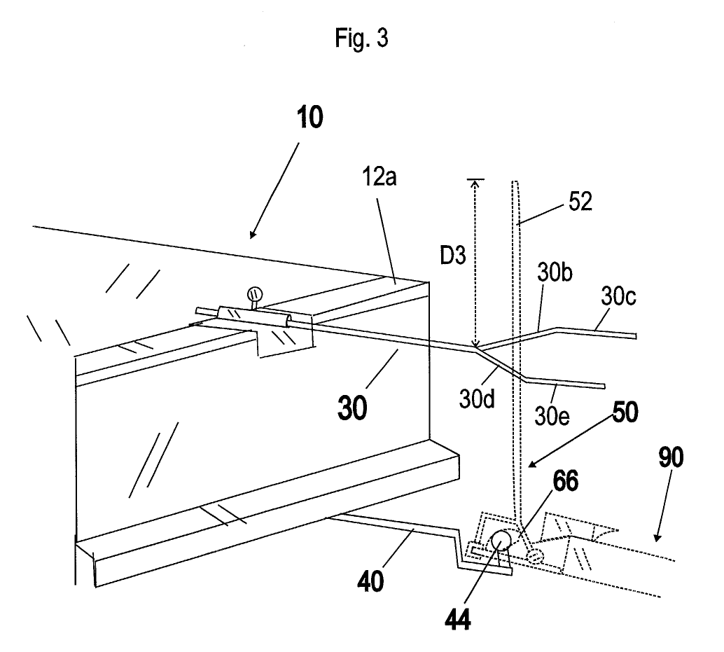

The individual may next fix the member 50 to the trailer portion 90 by inserting flange 68 into U-shaped portion 62 and then screwing in the screws 64a and 64b until the screws contact and screw into or indent the rounded portion 66 and hold the member 50 fixedly to the trailer portion 90. With the forked member 30 fixed to the pickup truck 110 and the member 50 fixed to the trailer portion 90, the individual can now back up the pickup truck 10 until the ball member 44 is lined up beneath the rounded portion 66 as shown in FIG. 2. FIG. 2 shows the pickup truck portion 10 and forked member 30 in dashed lines after backing up of the pickup truck 110 has occurred. When the rounded member 66 directly over and the ball member 44 the pole portion 52 of the member 50 is within the region 30g substantially encompassed by the fork member portions 30b, 30c, 30d, and 30e. It is relatively easy for the individual driving and backing up the pickup truck 110 to align the rounded member 66 over the ball member 44, because the individual can see the pole portion 52 easily from a rear view mirror of the pickup truck 110 or simply by looking out the rear window of the pickup truck 110. The pole portion 52 of the member 50 should extend substantially above the surface 12a of the back panel 12 so that an individual driving and backing up pickup truck 110 can easily see the pole portion 52. The pole portion 52 may extend a distance D3, shown in FIG. 3, which may be for example be twelve (12) inches above the surface 12a of the back panel 12. The distance D7, shown in FIG. 5 may be the distance from a line L2 perpendicular to the bottom 112a of the windshield 112 to the top of the pole portion 52 may be about twelve inches, but should be sufficient so that the pole portion 52 can be seen through the rear windshield 112. The line L2 shown in FIG. 5 is a line extending horizontally and perpendicularly from the bottom 112a of the windshield 112. The pole portion 52 extends above the bottom of the windshield 112a so that an individual backing up the pickup truck 110 can see the pole portion 52 and properly align the forked member 30 with the pole portion 52 of the member 50.

After the pickup truck 110 has been backed up to the position shown in FIG. 2 with respect to the portion 90 of the trailer 190, then the cinder block 76 can be removed or the trailer 190 or trailer portion 90 lowered by means of known equipment such as equipment which may be part of the trailer 190 or 90 and the portion 90 of the trailer 190 can be lowered onto the ball member 44. The rounded portion 66 of the portion 90 of the trailer 190 will lie on top of the ball member 44 and the ball member 44 will lie within the rounded portion 66 as shown in FIG. 3. FIG. 3 shows the trailer portion 90 in dashed lines. After the portion 90 of the trailer 190 has been lowered, the trailer portion 90 can be chained to the member 40 of the pickup truck 110 or connected in any other manner known in the art.

FIG. 4 shows a front view of the device 50. The device 50 may have a height of D4, which may be 40 inches from the top 52a of the pole member 52 to the top 62a of the U-shaped member 62. The distance, D6, between the outer edges of the diagonal members 56 and 54 may be two and one half inches. The height D5, of the member 60 may be two and one half inches. The U-shaped member 62 may have an inner width which may be slightly greater than the outer width of the flange 68 so the flange 68 can be inserted into the U-shaped member 62.

FIG. 5 shows a perspective view of the pickup truck 110 and the trailer 190 connected together and the device for aligning the pickup truck with the trailer.

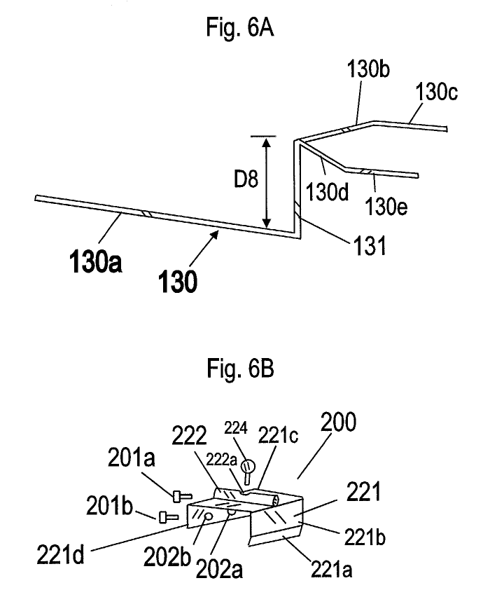

FIG. 6A shows an alternative forked member 130 in accordance with another embodiment of the present invention. The forked member 130 can replace forked member 30. The forked member 130 includes straight portion 130a, and portions 130b, 130c, 130d, and 130e similar to similarly numbered portions of forked member 30. However, the forked member also includes a vertical portion 131 which raises the portions 130b-e a distance D8 above the straight portion 130a. D8 may for example be six inches. In some cases this may be beneficial to allow an individual backing up a vehicle such as vehicle 110, to be able to see the portions 130b-e more easily when aligning the forked member with for example pole portion 52 of the member 50.

FIG. 6B shows a device 200 for connecting a forked member, such as 30 or 130 to a vehicle in accordance with various embodiments of the present invention. The device 200 includes a bracket 221 having plates 221a-d and a tube 222 for inserting a forked member such as 30 or 130. The device 200 also includes screws 201 a-b, and screw 224. The bracket 221 can be attached to a rear panel, such as 12, of a vehicle by screws 201a and 201b inserted through holes 202a and 202b, respectively, and then contacting the rear panel. The forked member 30 or 130 can be inserted into tube 222 and held by screw 24 which can be inserted into hole 222a. The plate 221a is angled from the vertical plate 221b to further help hold the bracket 221 to the rear panel, such as rear panel 12.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a device for aligning a vehicle with a trailer comprising
a first member which is fixed to the vehicle and which extends outward from the back of the vehicle; and
a second member which is fixed to the trailer and extends upward from the trailer;
wherein the first member and the second member can be aligned and wherein aligning the first and second members also aligns a first coupling device of the vehicle and a second coupling device of the trailer; and
wherein the first and second coupling devices when aligned can be coupled together to couple the vehicle to the trailer.

2. The apparatus of claim 1 wherein
the second member extends upward beyond the bottom of a rear windshield of the vehicle, when the first and second coupling devices are coupled together.

3. The apparatus of claim 1 wherein
the second member includes a pole portion which extends upward substantially perpendicularly to a beam member of the trailer.

4. The apparatus of claim 1 wherein
the first member is a forked member.

5. The apparatus of claim 4 wherein
the first member includes first and second prongs.

6. The apparatus of claim 5 wherein
the second member includes a pole portion which can fit within a region substantially encompassed by the first and second prongs.

7. The apparatus of claim 6 wherein
the second member includes a U-shaped portion which is connected to the pole portion;
and wherein a flange of the second coupling device of the trailer can be inserted into the U-shaped portion to fix the second member to the trailer.

8. The apparatus of claim 1 wherein
the first member is fixed to the vehicle by passing the first member through a hollow tube and fixing the first member to the hollow tube; and
wherein the hollow tube is fixed to the vehicle.

9. The apparatus of claim 1 wherein
the first member can be adjusted so that the first member can be fixed to extend outward different distances from the back of the vehicle.

10. The apparatus of claim 8 wherein
the first member can be adjusted so that the first member can be fixed to extend outward different distances from the back of the vehicle.

11. The apparatus of claim 1 wherein
the first member is fixed to the vehicle so that the region substantially enclosed by the first and second prongs lies directly above a member of the first coupling device which is directly connected to the second coupling device.

12. The apparatus of claim 11 wherein
the member of the first coupling device which is directly connected to the second coupling device is shaped substantially in the form of a ball.

13. A method comprising the steps of:
fixing a first member to a vehicle, so that the first member extends outward from the back of the vehicle; and
fixing a second member to a trailer, so that the second member extends upward from the trailer;
wherein the first member and the second member can be aligned and wherein aligning the first and second members also aligns a first coupling device of the vehicle and a second coupling device of the trailer; and
wherein the first and second coupling devices when aligned can be coupled together to couple the vehicle to the trailer.

14. The method of claim 13 wherein
the second member extends upward beyond the bottom of a rear windshield of the vehicle, when the first and second coupling devices are coupled together.

15. The method of claim 13 wherein
the second member includes a pole portion which extends upward substantially perpendicularly to a beam member of the trailer.

16. The method of claim 13 wherein
the first member is a forked member.

17. The method of claim 16 wherein
the first member includes first and second prongs.

18. The method of claim 17 wherein
the second member includes a pole portion which can fit within a region substantially encompassed by the first and second prongs.

19. The method of claim 18 wherein
the second member includes a U-shaped portion which is connected to the pole portion;
and wherein a flange of the second coupling device of the trailer can be inserted into the U-shaped portion to fix the second member to the trailer.

20. The method of claim 13 further comprising
fixing the first member to the vehicle by passing the first member through a hollow tube and fixing the first member to the hollow tube; and
wherein the hollow tube is fixed to the vehicle.

21. The method of claim 13 further comprising
adjusting the first member from extending outward a first distance from the back of the vehicle to a second distance.
